(19) United States
(12) Patent Application Publication
(10) Pub. No.: US 2026/0261487 A1
(43) Pub. Date: Sep. 3, 2026

(54) ARCHITECTURE FOR PREDICTIVE CONNECTIVITY FOR CLOUD-BASED DEVICES

(71) Applicant: KYOCERA Document Solutions Inc., Osaka (JP)

(72) Inventor: Austin James Watson, Seattle, WA (US)

(21) Appl. No.: 19/067,926

(22) Filed: Mar. 2, 2025

(51) Int. Cl. H04L 41/16; H04L 41/0681; H04L 41/0806; H04L 47/127; H04L 47/28; H04L 67/1008; H04N 1/00

(52) U.S. Cl. CPC H04L 41/16; H04L 41/0681; H04L 41/0806; H04L 47/127; H04L 47/28; H04L 67/1008; H04N 1/00039; H04N 1/00042; H04N 1/00079; H04N 1/00244; H04N 2201/0094

(57) ABSTRACT

Apparatuses, systems and methods relate generally to cloud-based equipment of a cloud network. In such a system, a network prediction module is configured to use first machine learning to predict network conditions using first historical data to provide predicted network conditions for the cloud network. A dynamic scheduling module in communication with the network prediction module is configured to determine optimal times for operations by the cloud-based equipment based on the predicted network conditions. A predictive load balancing module in communication with the network prediction module is configured to use second machine learning to forecast server loads using second historical data to provide forecasted server loads and to distribute tasks in response to the forecasted server loads to reduce high-load conditions on any single server of servers of the cloud-based equipment.

### FIELD

The following description relates to a predictive connectivity for cloud-based devices. More particularly, the following description relates to a system predictive connectivity optimization system for cloud-based device setup.

### BACKGROUND

Conventionally, a setup processes for cloud-based devices relied on traditional, manual configurations. Users faced challenges associated with network connectivity, leading to disruptions, inefficiencies, and user frustration. Conventional solutions lacked adaptability and proactive problem-solving capabilities needed for an optimal user experience. Accordingly, it would be desirable and useful to provide an adaptable and proactive system that addresses one or more of these issues.

### SUMMARY

In accordance with one or more below described examples, a system relating generally to cloud-based equipment of a cloud network is disclosed. In such a system, a network prediction module is configured to use first machine learning to predict network conditions using first historical data to provide predicted network conditions for the cloud network. A dynamic scheduling module in communication with the network prediction module is configured to determine optimal times for operations by the cloud-based equipment based on the predicted network conditions. A predictive load balancing module in communication with the network prediction module is configured to use second machine learning to forecast server loads using second historical data to provide forecasted server loads and to distribute tasks in response to the forecasted server loads to reduce high-load conditions on any single server of servers of the cloud-based equipment.

Other features will be recognized from consideration of the Detailed Description and Claims, which follow.

### BRIEF DESCRIPTION OF THE DRAWINGS

Accompanying drawings show exemplary apparatus(es) and/or method(s). However, the accompanying drawings should not be taken to limit the scope of the claims, but are for explanation and understanding only.

FIG. 1-1 is a flow diagram depicting an example of a predict network condition flow.

FIG. 1-2 is a flow diagram depicting an example of use case of the predict network condition flow of FIG. 1-1.

FIG. 1-3 is a flow diagram depicting an example of a dynamic scheduling system flow.

FIG. 1-4 is a flow diagram depicting an example of a use case of the dynamic scheduling system flow of FIG. 1-3.

FIG. 1-5 is a flow diagram depicting an example of a real-time (“RT”) notification module and an adaptive configuration recommendations (“ACR”) module flow.

FIG. 1-6 is a flow diagram depicting an example of a use case of the RT notification module and an ACR module flow of FIG. 1-5.

FIG. 1-7 is a flow diagram depicting a predictive load balancing module flow.

FIG. 1-8 is a flow diagram depicting an example of a use case of the predictive load balancing module flow of FIG. 1-7.

FIG. 2 is a block diagram depicting an example of a predictive cloud-based device setup architecture.

FIG. 3 is a flow diagram depicting an example of a user-centric setup process.

FIG. 4 is a pictorial diagram depicting an example of a network.

FIG. 5 is a block diagram depicting an example of a portable communication device.

FIG. 6 is a block diagram depicting an example of a multi-function printer (MFP).

FIG. 7 is a block diagram depicting an example of a computer system.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well known features have not been described in detail so as not to obscure the description of the examples herein. For ease of illustration, the same number labels are used in different diagrams to refer to the same items; however, in alternative examples the items may be different.

Exemplary apparatus(es) and/or method(s) are described herein. It should be understood that the word “exemplary” is used herein to mean “serving as an example, instance, or illustration.” Any example or feature described herein as “exemplary” is not necessarily to be construed as preferred or advantageous over other examples or features.

Before describing the examples illustratively depicted in the several figures, a general introduction is provided to further understanding.

A user-controlled artificial intelligence (AI) setup system tailored cloud-based devices, such as cloud printer or cloud scanner, is described. A system integrates AI predictions with user-centric control to enhance or optimize (“improve”) a setup process and improve device performance. Though cloud-based devices other than for cloud-print and cloud-scan may be used, for purposes of clarity by way of example and not limitation, a cloud-print and a cloud-scan operations are described.

A predictive system herein includes five modules, namely: a predictive network conditions module; a dynamic scheduling system module; a real-time notification system module; an adaptive configuration recommendations module; and a predictive load balancing module.

A predictive network conditions module includes a predictive network condition system for cloud printing and scanning software. A predictive network conditions module includes a NetworkConditionPredictor class configured to utilize historical network data and machine learning models to predict latency and stability for a given bandwidth. A predictive network condition system aims to improve network performance and reliability by anticipating network conditions.

A dynamic scheduling system module includes a dynamic scheduling code to improve a setup process for cloud print and scan devices. A dynamic scheduling system includes a DynamicScheduler class which may be configured to suggest optimal setup times based on predicted network conditions, such as for allowing users to schedule setups during periods of low latency and high stability.

A real-time notification system module includes a real-time notification system configured to alert users to changes in network conditions or configuration errors during a setup process. A real-time notification system may be configured to send notifications to users, such as for example to provide timely information and allow prompt intervention to resolve issues and ensure smooth operation.

An adaptive configuration recommendations module includes an adaptive configuration recommendation system configured to adjust device configurations based on predicted network conditions and user preferences. An adaptive configuration recommendation system includes an AdaptiveConfigurator class configured to dynamically modify settings to improve performance, prioritizing stability or speed depending on network conditions.

A predictive load balancing module includes predictive load balancing system. A predictive load balancing system includes a PredictiveModel class configured to simulate predictive analytics for load balancing. A predictive load balancing system may be configured to generate load predictions for each server based on historical data and machine learning algorithms, allowing proactive load balancing and resource allocation improvement in anticipation of future demand.

These modules in combination provide in part an architecture of an intelligent setup wizard, powered by artificial intelligence and machine learning, which may predict potential connectivity issues in real-time and proactively suggests solutions. This architecture may learn from historical data, adapting to a user's environment, network conditions, and device capabilities. This architecture may monitor network conditions continuously, dynamically adjusting its configuration recommendations. It's like having a virtual assistant that not only guides a user through a setup but also anticipates and resolves connectivity challenges before they impact a user's workflow. Such an adaptive architecture may optimize protocols based on predicted network conditions, recommend adjustments to enhance performance, and provide user-friendly notifications for a smooth experience.

Beyond just a setup wizard; a proactive solution may ensure cloud-based devices operate optimally with minimized disruptions and maximized efficiency. Users may benefit from an architecture that not only identifies issues in real-time but also provides immediate, automated solutions, reducing user intervention and minimizing disruptions. With the continuous learning capabilities based on historical data, this architecture may ensure that a setup process evolves over time, adapting to the specific conditions of a user's environment. This may ensure that such architecture solution remains effective and relevant in the face of changing network landscapes. This architecture may predict and proactively address potential connectivity issues, optimizing a device's connection to cloud services. This architecture may continuously monitor network conditions, analyzing bandwidth, latency, and stability.

Machine learning algorithms may learn from historical data, identifying patterns associated with common network issues. Real-time monitoring may utilize real-time monitoring tools to track fluctuations in network performance and identify potential disruptions. Dynamic configuration suggestions may adapt configuration suggestions based on observed and predicted network conditions and recommends adjustments, such as for example to print quality settings or scheduling large print jobs during off-peak hours. Adaptive protocol selection may intelligently select communication protocols based on predicted network conditions, and recommends robust protocols for large scan jobs during expected connectivity instability. Proactive issue resolution may proactively suggest solutions to potential connectivity issues in real-time and may recommends router adjustments, network equipment upgrades, or optimization tips. User-friendly notifications may communicate predictive suggestions through user-friendly notifications within a setup wizard. Historical data for continuous improvement may leverage historical data to improve predictive capabilities over time and may ensures continuous learning and adaptation to evolving network conditions.

In summary, an intelligent setup wizard that leverages AI and machine learning to predict and proactively address connectivity challenges is described. This architecture aims to enhance efficiency, adaptability, and overall user satisfaction in a setup process, aligning with evolving needs of modern cloud-based environments, such as for example cloud-based printing and scanning environments.

With the above general understanding borne in mind, various configurations for systems, and methods therefor, for setup architecture are generally described.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples.

For purposes of explanation, specific nomenclature is set forth to provide a thorough understanding of the various concepts disclosed herein. However, the terminology used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc., may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object-oriented programming language such as Python, Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (“LAN”) or a wide area network (“WAN”), or the connection may be made to an external computer (for example, through the Internet using an Internet Service Provider).

Systems and methods described herein may relate to an apparatus for performing the operations associated therewith. This apparatus may be specially constructed for the purposes identified, or it may include a general-purpose computer selectively activated or reconfigured by a computer program stored in the computer.

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein.

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also, two or more operations may be performed concurrently or with partial concurrence. Such variation will depend on the software and hardware systems chosen and on designer choice. It is understood that all such variations are within the scope of the disclosure. Likewise, software and web implementations may be accomplished with standard programming techniques with rule-based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs.

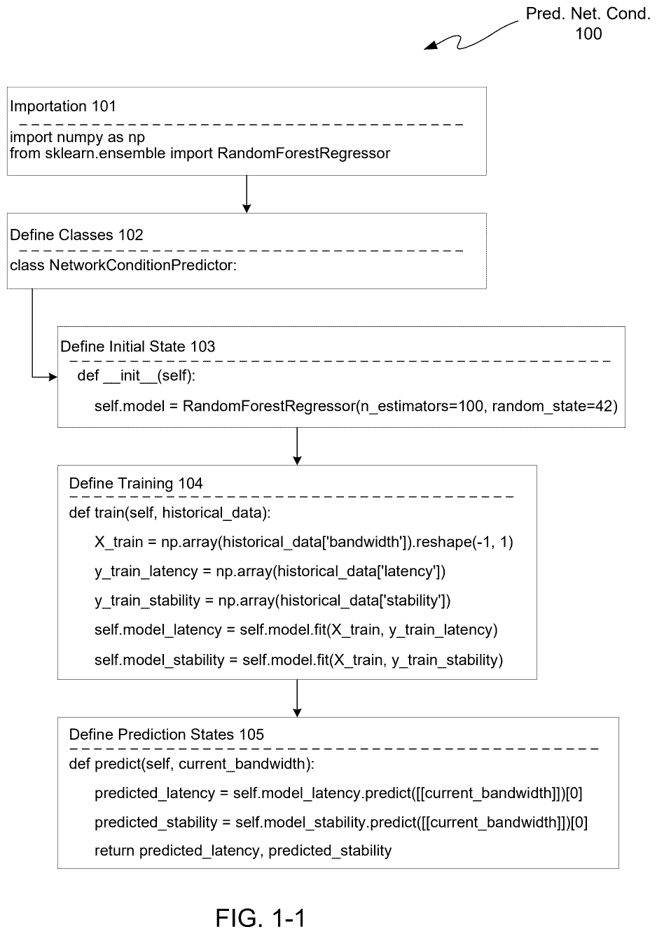

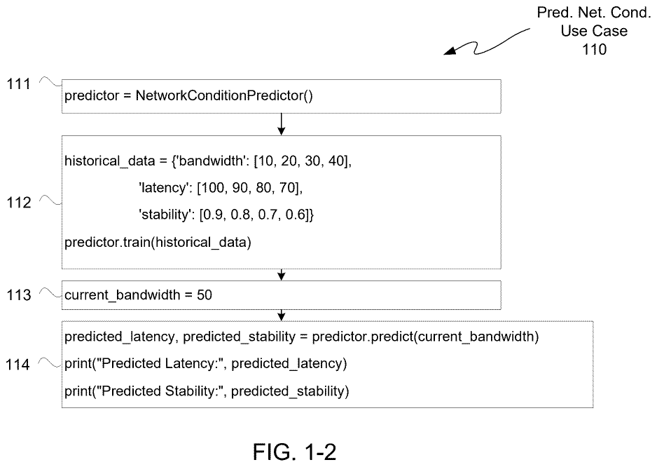

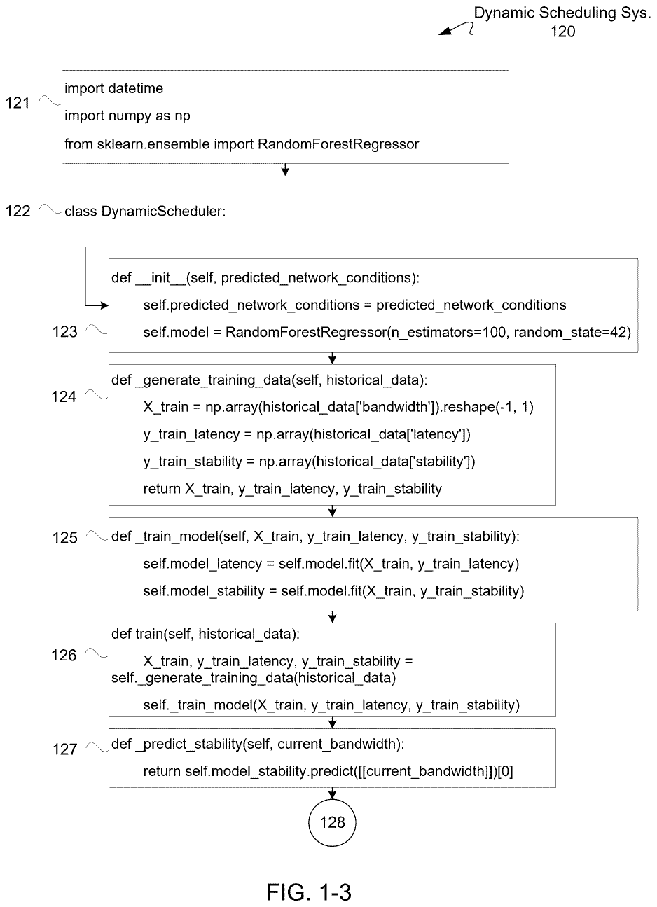

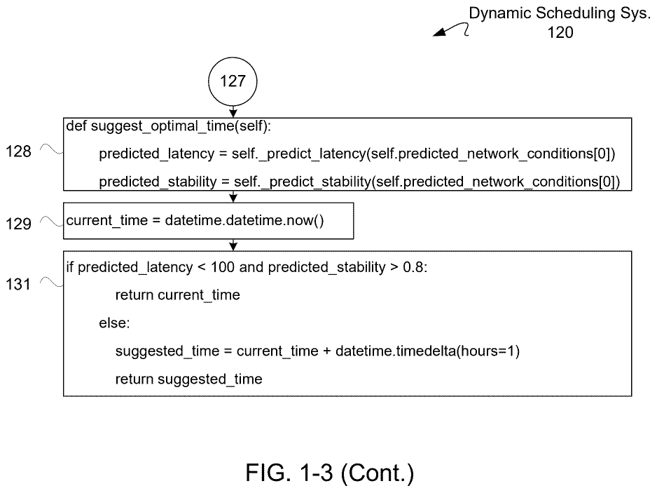

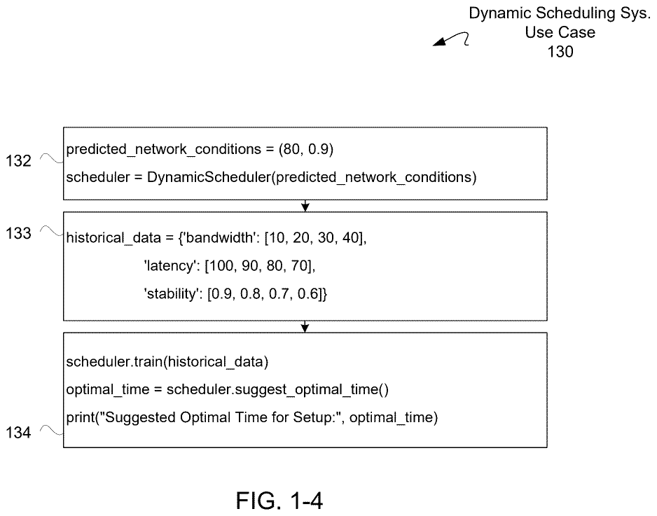

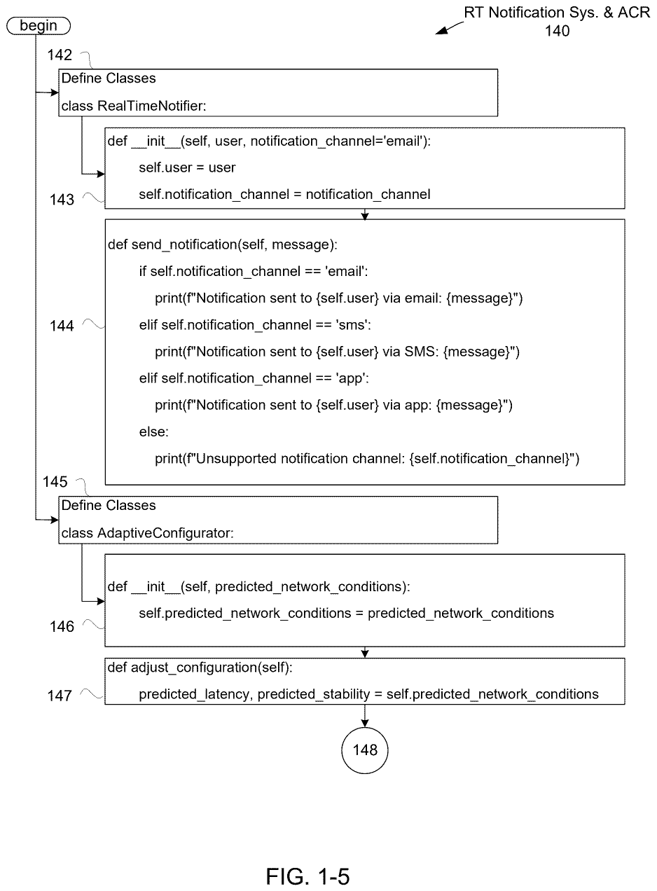

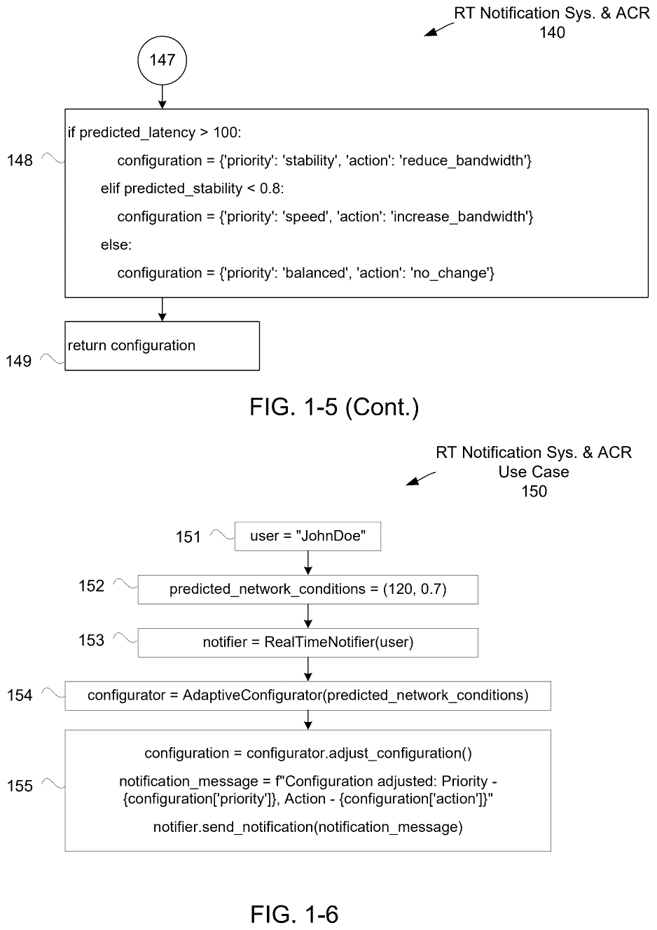

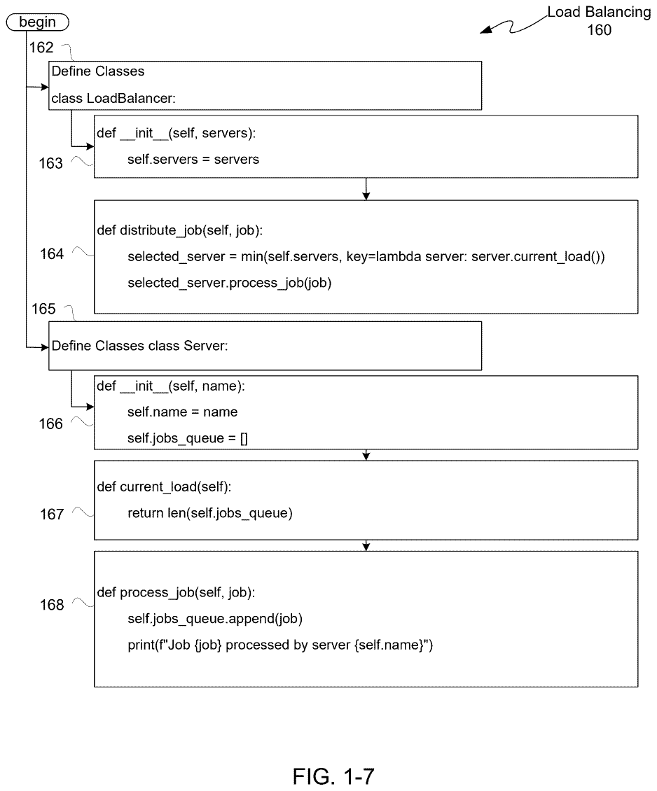

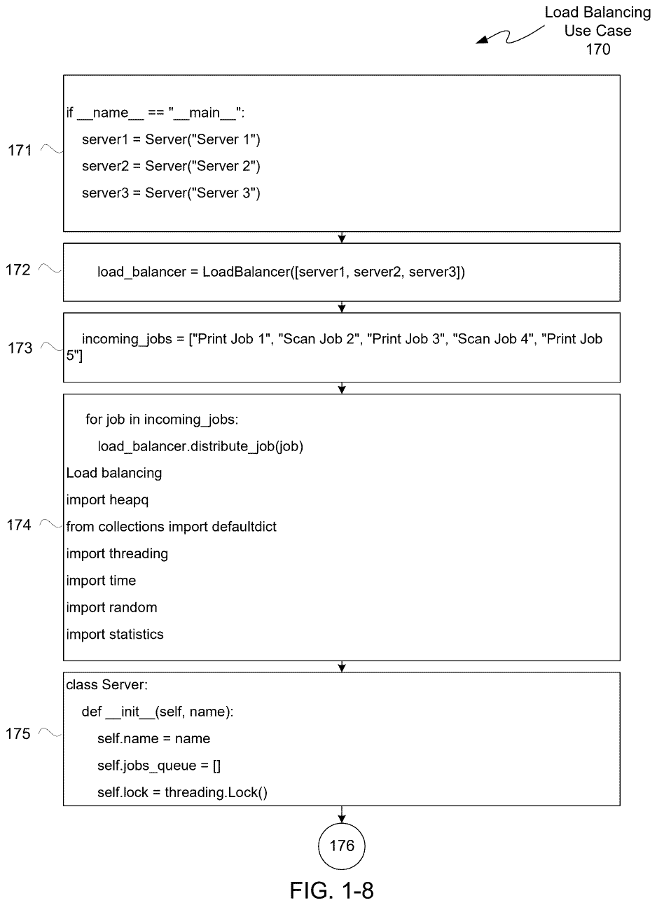

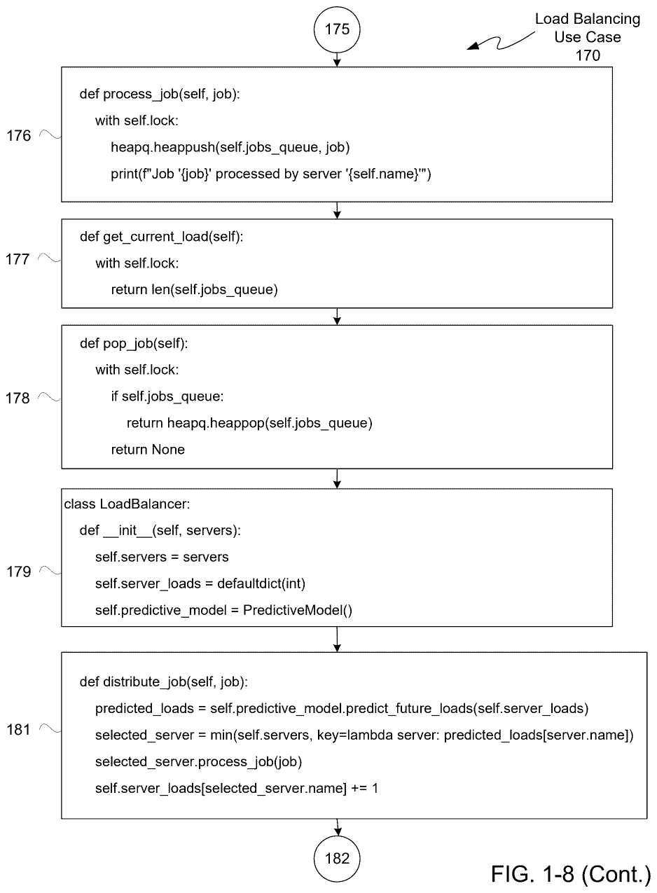

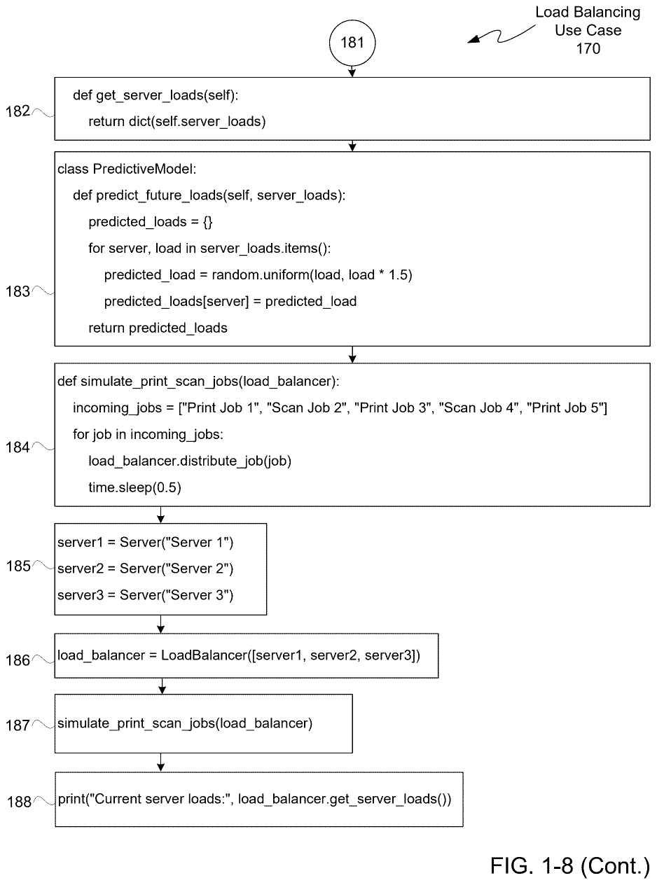

FIG. 1-1 is a flow diagram depicting an example of a predict network condition flow 100. Prediction network condition flow 100 may be a module of a process for predictive connectivity for a cloud-based device of a cloud network or cloud. Again, for purposes of clarity by way of example and not limitation, a cloud-based device may be a printing or scanning system, such a standalone printer, a standalone scanner, a multi-function printer (MFP; sometimes referred to as an “All-in-One Printer”), or like document processing equipment or devices. Additionally, a cloud-based device may be a server. There may be multiple servers as cloud-based devices or equipment for serving a printing or scanning system as part of such cloud. Generally, cloud-based printers or printing devices, scanners, and servers may be considered cloud-based equipment even if not co-located with servers of such cloud network.

A network prediction or predictive network condition module utilizes AI to predict network conditions, such as bandwidth fluctuations, latency variations, stability issues, and qualities of one or more of these. During an initial setup process, a predictive network condition system may analyze historical network data and predict future, or what will be current, network conditions, which may include predictions for latency and stability.

Conventional tools may be used for measuring latency in milliseconds. For example, a ping test, a traceroute, dedicated network monitoring tools and software solutions, or application-level monitoring to include built-in mechanisms for measuring latency during data transmission. Conventional tools may be used for measuring stability. Packet loss rate may be measured by monitoring the percentage of packets lost during transmission. Jitter may be measured by analyzing the variance in packet arrival times over time. Latency variation, also known as latency jitter, refers to fluctuations in the delay experienced by packets traveling across the network, namely measuring latency variation by monitoring changes in latency over time. Furthermore, various network performance metrics, such as throughput, round-trip time or RTT (units measured by milliseconds), and error rates (units measured by ratio or percentage), can also indicate network stability.

For purposes of clarity by way of example and not limitation, latency as described below herein is measured in milliseconds; and stability is measured as a percentage or index value.

Users input their network specifications, and a predictive network condition system provides recommendations for optimal setup times based on predicted network conditions. This helps users schedule a setup process during periods of low latency and high stability, reducing or minimizing the risk of setup failures due to network issues. As described below in additional detail, a predictor may be trained on data such as bandwidth, latency, stability, or the like, to facilitate accurate forecasts of network conditions. Such a system suggests optimal conditions for setup to reduce likelihood of network-related setup issues.

At operation 101, a processing package and a machine learning regressor may be imported. In this example a general-purpose array-processing package for Python is imported, namely NumPy or “numpy”. However, another type of language, such as for example C/C++, Pascal or the like, may be used in another example for import of a machine learning regressor. NumPy provides a high-performance multidimensional array object and tools for working with these arrays or more particularly array objects.

Further at operation 101, a machine learning (ML) regressor may be imported. In machine learning, a go-to libraries for Python is Scikit-learn or “sklearn”, which may be used for creation of ML models. Scikit-learn is an ML library with tools for data analysis and modeling. Being built on NumPy, SciPy, and Matplotlib, sklearn may be used for tasks like classification, regression, clustering, and dimensionality reduction. In this example, an sklearn. ensemble library import is of a Random Forest Regressor, but in another example another ML regressor may be used for predicting numbers based on other numbers. An ensemble is used to combine predictions from different models (i.e., to stack model on model) to generate a final prediction, which in this example is by a Random Forest Regressor but another ML regressor may be used in another example.

At operation 102, classes are defined for a class of a network condition predictor, namely “NetworkConditionPredictor”. Operations for a network condition predictor class for an initial state class may be from operations 103 through 105 under operation 102 to define classes for a network condition predictor class. A class may be defined at operation 103 for a predictive model or a “self” model; a training data set class may be defined at operation 104 for such self model; and a prediction states class may be defined at operation 105 for such self model.

In this example, at operation 103, a self model is initialized and set as a Random Forrest Regressor for ML. In this example, such a Random Forest Regressor is configured to process historical data and predict network stability and latency based on current bandwidth. In this example, there are 100 estimators and 42 random states for such ML regression; however, in another example other values of numbers of estimators or random states may be used, as well as another type of regressor.

In this example, at operation 104, a self model is defined for training using historical data. In this example, historical data for bandwidth, latency, and stability are each effectively processed with an NumPy array to generate three sets of trained data one for each of bandwidth, latency, and stability. Bandwidth, or more particularly an array of bandwidth information in a NumPy array, may have an associated array reshaped without any changing of data in such array.

Further at operation 104, generated training data for bandwidth, latency and stability may be fit to a self model for predicting latency using bandwidth and latency training data and fit to such a self model for predicting stability using bandwidth and stability training data. Basically, a fit function processes training data as arguments. This may be one array for unsupervised learning or two arrays for supervised learning.

With a self model trained for latency and stability at operation 104, at operation 105 a define prediction states class 105 may be performed. A self model may obtain a current bandwidth to define a predict function, as described below in additional detail. Generally, a predict(function) performs a prediction for each instance accepting a single input therefor.

In the example of operation 105, self model latency is predicted for a current bandwidth, and self model stability is predicted for such a current bandwidth. Predicted latency and stability may be returned as outputs at operation 105. A network prediction module may thus utilizes historical network metrics to train a predictive model associated with machine learning and to iteratively train such a predictive model with generated predicted network conditions as predictions made at specified intervals to account for fluctuating network conditions.

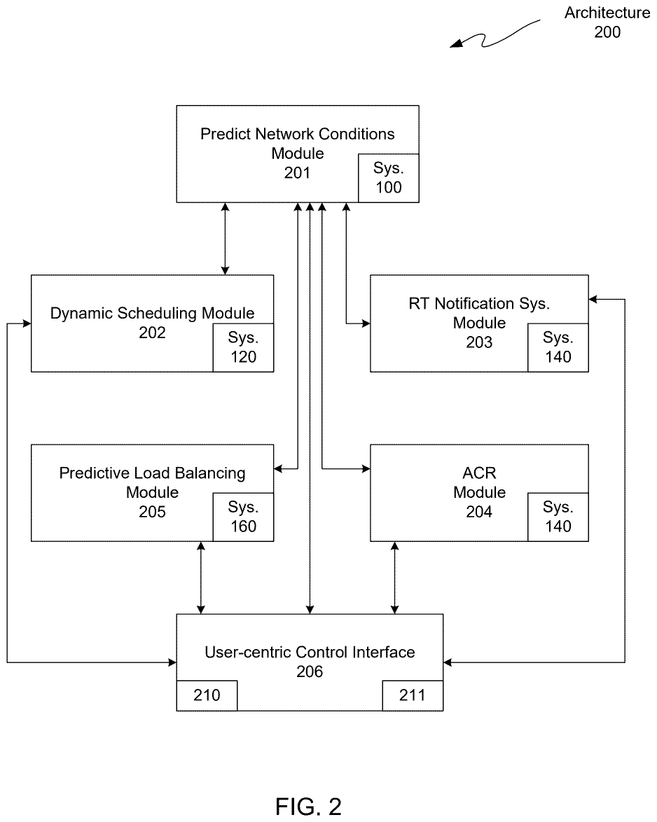

FIG. 1-2 is a flow diagram depicting an example of use case 110 of predict network condition flow 100 of FIG. 1-1. With simultaneous reference to FIGS. 1-1 and 1-2, use case 110 is further described.

At operation 111, an example usage may be initiated to predict a network condition with a NetworkConditionPredictor(), as previously described. At operation 112, historical network data may be simulated. In this example, data sets for bandwidth, latency and stability, namely respectively bandwidth [10, 20, 30, 40], latency [100, 90, 80, 70], and stability [0.9, 0.8, 0.7, 0.6], are used to provide historical data. Of course, these or other data sets may be used in other examples.

Further at operation 112, this example historical data is input to a predictor train function or model. At operation 113, predict network conditions for a current bandwidth may be set. In this example, a current bandwidth is set to 50; however, in other examples other values may be used.

At operation 114, predictions for a current bandwidth may be generated. Along those lines stability and latency may be predicted for a current bandwidth, in accordance with the previous description. Further at operation 114, in this example predicted latency and predicted stability may be output as a printed output. However, in other examples, other forms of output may be used.

FIG. 1-3 is a flow diagram depicting an example of a dynamic scheduling system flow 120. Dynamic scheduling system flow 120 may be a module of a process for predictive connectivity for a cloud-based device. Again, for purposes of clarity by way of example and not limitation, a cloud-based device may include a printing or scanning system, such a standalone printer, a standalone scanner, an MFP; or like device.

A dynamic scheduling system improves a setup process by suggesting ideal or best case setup times based on predicted network conditions. Users input their desired setup time window, and a dynamic scheduling system dynamically adjusts scheduling to ensure improved performance. This ensures that setup tasks are executed efficiently, reducing setup time and minimizing disruption to each users' workflow.

At operation 121, importations may be made. For example, a datetime, a numpy or NumPy as previously described, and a RandomForestRegressor from sklearn may all be imported. At 122, classes for a dynamic scheduler class may be defined. Operations 123 through 128 are for defining classes for a dynamic scheduler class. As described herein, a dynamic scheduling module may use a Random Forest model to generate latency and stability estimates for each device setup based on specified bandwidth thresholds.

At operation 123, an initial set of information is defined for a self model including for a regressor. The same example of FIG. 1-1 is continued for purposes of clarity and not limitation.

At operation 124, a generation of a training data set is defined for such a self model for historical data. X_train, y_train_latency and y_train_stability are generated from historical data, such as previously described. Such X_train, y_train_latency and y_train_stability values may be returned at operation 124.

At operation 125, a train model is defined for X_train, y_train_latency and y_train_stability values returned at 124, and fit operations for latency and stability are performed as previously described.

At operation 126, a train set is defined for a self model and historical data. X_train, y_train_latency and y_train_stability may be generated from a self model generating training data based on historical data. Such generated X_train, y_train_latency and y_train_stability may be used to provide a self train model.

At operation 127, prediction of stability from a self model and current bandwidth may be defined. A prediction with such current bandwidth from such self model for stability may be returned.

At operation 128, a suggested optimal time for such self model may be defined. Latency and stability may each be predicted from network conditions and such self model.

At operation 129, a current date and time may be used to set a current time.

At operation 131, if latency predicted at 128 is less than 100 milliseconds (or other time threshold in another example), and if stability predicted at 128 is greater than 0.8 or 80 percent (or some other threshold value in another example), then a current time value is returned as a good time to schedule. If, however, either predicted latency or stability is not less than 100 milliseconds or 80% respectively, then a suggested time is generated and returned. In this example, a suggested time may be one hour later than a current time; however, in another example another suggested time may be used.

FIG. 1-4 is a flow diagram depicting an example of a use case 130 of a dynamic scheduling system flow 120 of FIG. 1-3. With simultaneous reference to FIGS. 1-1 through 1-4, use case 130 is further described.

At operation 132, network conditions to be predicted are set. In this example, a less than 80 millisecond latency and a greater than 90% stability are used as such conditions to be predicted; however, in other example, one or both of these values may be different. A scheduler is set equal to output of a dynamic scheduling system module for such network conditions set.

At operation 133, historical network data may be simulated for bandwidth, latency and stability. Example values for each are used for purposes of clarity and not limitation.

At operation 134, a scheduler may be trained with such historical data. Such a scheduler may output a suggested optimal time for setup. Such suggested optimal time for setup may be output, which in this example is a print output but another type of output may be used in another example.

FIG. 1-5 is a flow diagram depicting an example of a real-time (“RT”) notification module and an adaptive configuration recommendations (“ACR”) module flow 140. An RT notifications module alerts users to changes in network conditions or configuration errors during a setup process. An ACR module provides adaptive configuration recommendations based on predicted network conditions and user preferences.

Throughout a setup process, an RT notification system of a real-time notifications module monitors network conditions and configuration changes in real-time. If network conditions deteriorate or configuration errors occur, RT notification system sends real-time notifications to users, alerting them to potential issues. Users may then take prompt action to resolve issues, ensuring smooth setup and operation of cloud devices, such as cloud printing and scanning devices.

As a setup progresses, an ACR system of an ACR module dynamically adjusts device configurations based on predicted network conditions and user preferences. An ACR system continuously monitors network performance and user feedback, optimizing device settings to prioritize stability or speed as required. This adaptive approach ensures that device configurations are tailored to a current network environment, maximizing performance and user satisfaction.

At operation 142, classes may be defined for a RT notification system, namely a RealTimeNotifier class. Operations 143 and 144 are for defining classes for an RealTimeNotifier class.

At operation 143, a self model, a user and a notification channel initialization are defined. In this example, an email channel is used; however, in another example another communication channel may be used.

At operation 144, a send notification may be defined. Various placed holders for sending a notification via various channels, like email, SMS, or app notifications, may likewise be provides, as well as a notification for an unsupported channel.

For an ACR system, at operation 145, an ACR class, namely AdaptiveConfigurator class, may be defined. Operations 146 and 147 are for defining classes for an AdaptiveConfigurator class.

At operation 146, initialization of a self model and predicted network conditions may be defined. At operation 147, an adjust configuration for a self model may be defined. From such predicted network conditions, predicted latency and stability values may be obtained.

At operation 148, adaptive configuration adjustments may be simulated based on predicted network conditions. In this example, if predicted latency is high, namely greater than 100 milliseconds for example, then a configuration is adjusted to prioritize stability over speed. If predicted stability is low, namely less than 80% in this example, then a configuration is adjusted to optimized for speed over stability. Lastly, if predicted network conditions are favorable for latency and stability, then a current configuration is maintained. At operation 149, one of such configurations determined at operation 148 may be returned.

Throughout a setup process, an RT notification system monitors network conditions and configuration changes in real-time. If network conditions deteriorate or configuration errors occur, RT notification system sends real-time notifications to users, alerting them to potential issues. Users can take prompt action to resolve issues, ensuring smooth setup and operation of cloud printing and scanning devices.

FIG. 1-6 is a flow diagram depicting an example of a use case 150 of an RT notification module and an ACR module flow 140 of FIG. 1-5. With simultaneous reference to FIGS. 1-1 through 1-6, use case 150 is further described.

At operation 151, a user is set. In this example a user is JohnDoe; however, in another example a different user may be set.

At operation 152, there may be predicted network conditions for latency and stability. In this example, 120 milliseconds and 70% are respectively predicted for latency and stability; however, in another example other network conditions may be predicted.

At operation 153, a real-time notifier is created for a user. At operation 154, created is an adaptive configurator based on predicted network conditions. At operation 155, adjusting configuration and sending notifications is simulated.

As a setup progresses, an ACR system dynamically adjusts device configurations based on predicted network conditions and user preferences. An ACR system continuously monitors network performance and user feedback, optimizing device settings to prioritize stability or speed on an as needed basis. This adaptive approach ensures that device configurations are tailored to a current network environment, for maximizing performance.

FIG. 1-7 is a flow diagram depicting a predictive load balancing module flow 160. At operation 162, a load balancer class may be defined. Operations 163 and 164 are for defining classes for a load balancer class.

At operation 163, an initialization may be defined as a function of self and servers.

At 164, a distribute job as a function of self and job may be defined. Further at operation 164, a server with a lowest current load may be selected or chosen.

At operation 165, a server class may be defined. Operations 166 through 168 are for defining classes for such a server class.

At operation 166, an initialization as a functions of self and name may be defined along with a number of jobs in a queue.

At operation 167, a current load as a function of self may be defined. Further at operation 167, a current load may be calculated or determined based on the number of jobs currently in a jobs queue.

At operation 168, a process job as a function of self and job may be defined. Further at operation 168, an incoming job may be processed, and an indication of processing of such job may be output.

After an initial setup, a predictive load balancing system continuously monitors server loads and predicts future demand based on historical data and machine learning algorithms. When such a predictive load balancing system detects an increase in workload or predicts high demand, it proactively redistributes print and scan jobs among available servers to avoid CPU high-load issues. By balancing workload across servers in anticipation of future demand, a predictive load balancing system prevents performance degradation and ensures smooth operation of cloud printing and scanning services.

An auto-predict is included in the code. A PredictiveModel class is already included in the code for predictive load balancing. Therefore, there's no need for additional auto-predict functionality as it's already integrated into a load balancing system as described herein. A PredictiveModel class handles the prediction of future server loads based on historical data, which is a component of a load balancing algorithm described herein.

FIG. 1-8 is a flow diagram depicting an example of a use case 170 of a predictive load balancing module flow 160 of FIG. 1-7. With simultaneous reference to FIGS. 1-1 through 1-8, use case 170 is further described.

At operation 171, servers are created. In this example, servers 1, 2, and 3 are created; however, in another example fewer or more servers may be created.

At operation 172, a load balancer of predictive load balancing module flow 170 is initialized with one or more servers. In this example, a load balancer is initialized with servers 1, 2, and 3. By incorporating predictive analytics into a load balancing algorithm, this code goes beyond traditional reactive load balancing techniques. It allows a load balancing system to adapt to changing workload patterns and optimize resource allocation in real-time, leading to improved performance and efficiency. Along those lines, balancing load distribution across ones of cloud-based devices of a cloud-based network may be performed using predictive analytics to anticipate future demand and prevent overloading.

At operation 173, incoming jobs are simulated. In this example, print jobs 1, 3, and 5 and scan jobs 2 and 4 are simulated as incoming jobs. However, in another example, a different mix of print and scan jobs may occur.

At operation 174, such incoming jobs of operation 173 may be distributed using a load balancer initialized at operation 172. Further at operation 174, load balancing may be performed. Additionally, at operation 174, importations of a heapq, threading, time, random, and statistics may be performed, along with import of a dictionary in Python, namely defaultdict, from collections.

At operation 175, a server class may be defined. Such defining may include defining an initialization of a self model and a name for same. A priority queue for jobs may be defined, and a lock for thread safety may be defined.

At operation 176, a process for a job may be defined for self and job. Further at operation 176, a job may be processed by a server, and an indication of such processing may be output.

At operation 177, a current load for self may be defined. Further at operation 177, a current load, namely a current number of jobs in a queue, may be returned.

At operation 178, a pop job may be defined for self. Further, at operation 178 a pop, namely pop of a job's queue, and return the next job to process in such queue, such as a highest priority job remaining, may be performed.

At operation 179, a load balancer class may be defined. Initialization of self and servers may be defined. Server loads may be tracked, such as with integer values of defaultdict. Lastly, a predictive model may be initialized.

At operation 181, a distribute job as functions of self and job may be defined. Further at operation 181, a server may be chosen. A selected server may be chosen as the server predicted to have a lowest future load. After selection of such a server, such a selected server may have its server load updated at operation 181.

At operation 182, obtained server loads are defined as a function of self. Further at operation 182, all current loads for all servers may be returned.

At operation 183, a class predictive model may be defined. A prediction of future loads as a function of self and server loads may be defined as a class. Further at operation 183, predictive analytics may be simulated based on historical data and machine learning. A PredictiveModel class may be introduced to simulate predictive analytics for load balancing. This PredictiveModel class may generate load predictions for each server based on historical data and machine learning algorithms.

Along those lines, a random load prediction may be generated based on historical data. A load increase of up to 50% more, namely multiplied by 1.5, may be predicted. Of course, in another example, another prediction weight may be used. Further at operation 183, predicted loads may be returned.

A LoadBalancer class now selects servers based on predicted future loads rather than current loads. This dynamic load distribution allows for proactive load balancing, ensuring that jobs, such as print and scan jobs, are distributed to servers, such as of a cloud-based network, in anticipation of future demand.

At operation 184, a simulation of print scan jobs as a function of a load balancer may be defined. Further at operation 184, incoming print and scan jobs may be simulated. Again, the example of the mix and numbers of print jobs and scan jobs is merely for purposes of clarity and not limitation. At operation 184, a load balancer may distribute such jobs, and a simulation of processing time may be performed.

At operation 185, servers may be created. Again, an example of servers 1 through 3 is merely for clarity, and in other examples fewer or more servers may be created. At operation 186, a load balance may be initialized with servers, such as servers 1 through 3 in this example.

At operation 187, incoming jobs, such as incoming print and scan jobs for example, may be simulated. At operation 188, current loads for all servers may be fetched or obtained.

A load balancing system periodically checks the current load on each server and compares it to predicted future loads. If a server's load is predicted to exceed a predefined threshold, such load balancing system reallocates jobs to other servers with lower predicted loads. This proactive approach to load balancing prevents overloading of individual servers, mitigating CPU high-load issues and maintaining optimal performance of a cloud printing and scanning infrastructure.

FIG. 2 is a block diagram depicting an example of a predictive cloud-based device setup architecture 200. Architecture 200 includes modules 201 through 205, as well as a user-centric control interface 206. Such a user-centric control interface 206 allows users to interact with architecture 200 modules, including making configuration choices, and receiving notifications. User-centric control interface 206 may include a web-app 210 for interacting with architecture 200 modules, as well as a computer assistant 211 for aiding a user through a setup wizard.

A network predictions module or predictive network connectivity module 201, which may include a system or flow 100 previously described, utilizes AI to predict future network conditions, such as bandwidth fluctuations, latency variations, and stability issues to emerge in the future. Such future may be near future events such as several seconds to several minutes or distant future events such as several minutes to tens of minutes in advance of a present state. A dynamic scheduling system module 202, which may include a system or flow 120 as previously described, allows users to select optimal setup times based on predicted network conditions. Uses the predicted network conditions to schedule setups during optimal time frames. For example, if predicted latency is below a threshold and stability is high, dynamic scheduling system module 202 may suggest an immediate setup; otherwise, dynamic scheduling system module 202 may reschedule to a more suitable time for setup.

An RT notifications module 203, which may include a portion of a system or flow 140 as previously described, alerts users to changes in network conditions or configuration errors during a setup process. An adaptive configuration recommendation or ARC module 204, which may include a portion of a system or flow 140 as previously described, provides adaptive configuration recommendations based on predicted network conditions and user preferences.

With respect to load balancing, a predictive load balancing module 205, which may include a system or flow 160 as previously described, includes a PredictiveModel class to allow a load balancer to make decisions based on predicted future loads rather than just current loads. This proactive approach to load balancing, leveraging predictive analytics and machine learning, can significantly improve system performance and resource utilization. Such a predictive load balancing module 205 provides dynamic load distribution. By selecting servers based on predicted future loads, a load balancer can anticipate demand and distribute jobs accordingly. This dynamic allocation of resources may ensure optimal utilization and help prevent overloading of any single server, leading to improved system stability and responsiveness. Incorporation of predictive analytics into a predictive load balancing module 205 represents a departure from traditional reactive load balancing techniques. This predictive approach allows a system 160 thereof to adapt in real-time to changing workload patterns, optimizing resource allocation and improving overall system efficiency. Although a predictive load balancing module 205 simulates predictive analytics with simple random load predictions in an example for purposes of clarity, more sophisticated predictive models based on historical data and advanced machine learning algorithms may be used as is opened up by this approach.

By integrating these modules 201 through 205 into a setup process and ongoing operation of cloud printing and scanning systems, users can experience improved reliability, efficiency, and performance while minimizing the risk of network-related issues and CPU high-load problems.

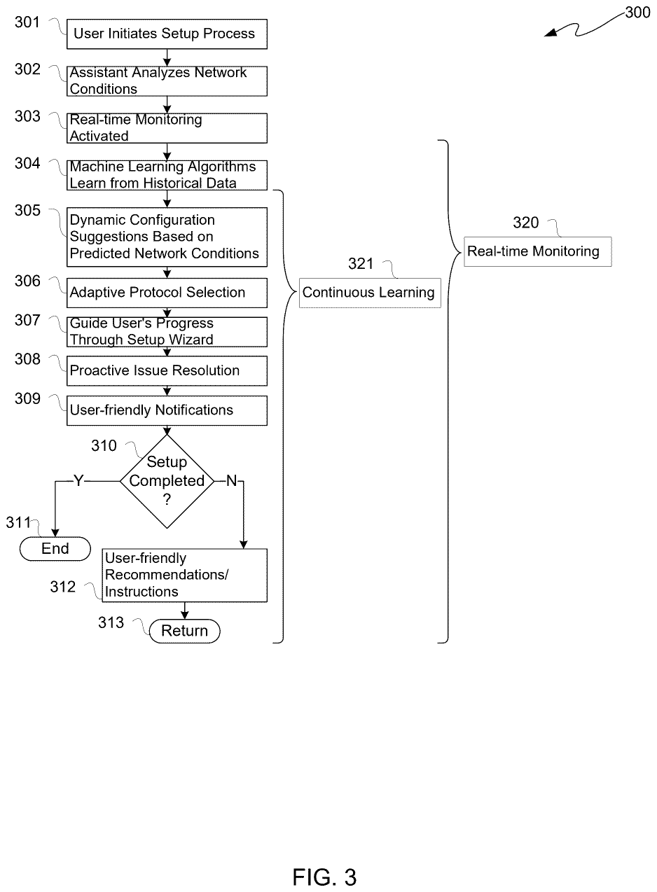

FIG. 3 is a flow diagram depicting an example of a user-centric setup process 300. User-centric setup process 300 is further described with simultaneous reference to FIGS. 1-1 through 3.

At operation 301, a user initiates a setup process, such as initiates a setup wizard. For purposes of clarity by way of example and not limitation, such a setup process is described for a cloud-based print and scan device; however, in other instances other types of cloud-based devices may benefit from one or more aspects of a setup process as described herein.

At operation 302, a computer assistant initializes analysis of and to predict network conditions. At this juncture a predictive connectivity optimization system, such as previously described, may begin analyzing a user's network conditions, considering factors such as bandwidth, latency, and stability.

At operation 303, real-time monitoring may be activated. This real-time monitoring 320 may continue throughout a remainder of user-centric setup process 300. Real-time monitoring tools, such as previously described, are activated to track network performance throughout a setup process. A computer assistant continues real-rime monitoring of network conditions in throughout a setup process.

At operation 304, machine learning algorithms may learn from historical data. As previously described, architecture 200 uses machine learning algorithms to learn from historical data, identifying patterns associated with common network issues. Machine learning 321 may continue throughout a remainder of user-centric setup process 300 and thereafter. A computer assistant 211 of architecture 200 leverages historical data to continuously improve its predictive capabilities for future setup processes.

At operation 305, dynamic configuration suggestions may be generated based on predicted network conditions, as previously described. A computer assistant dynamically adapts its configuration suggestions based on observed and predicted network conditions. Leveraging advanced AI predictions, architecture 200 includes a dynamic scheduling module to guide a user in selecting an optimal time slot for a setup process. As a user initiates a setup process, expressing a preference for daytime or other configuration aligned with their document management activities, architecture 200, through continual analysis of historical data and real-time network conditions, may foresee potential connectivity challenges during daytime or other hours. In response, architecture 200 dynamically generates a schedule, showcasing time slots predicted to offer optimal connectivity, such as for example during non-peak hours or periods with historically stable conditions.

Empowered with this information, a user may select a suitable time slot based on their schedule. However, as a selected scheduled time approaches, an AI may predict an unforeseen decline in network stability during such initially chosen slot. To ensure a seamless setup experience, architecture 200 may promptly notify such user through alert notifications and in-app messages, detailing each predicted connectivity issue and suggesting one or more alternative time slots with more favorable network conditions. With this information, a user may make an informed decision to reschedule a setup to a time slot that aligns with a dynamically changing network landscape. As a result, a user may proceed with a setup during an adjusted time, to have a smooth and uninterrupted configuration process, highlighting this architecture's adaptability and user-centered notifications.

Other items that an AI could predict include packet loss prediction, jitter prediction, firewall interference prediction, DNS (domain name system) resolution issues prediction, bandwidth throttling prediction, interference from nearby devices prediction, traffic spikes prediction, or quality of service (QoS) fluctuations prediction, among others.

At operation 306, a protocol selection may be made adapted to network conditions. At operation 306, architecture 200 intelligently selects communication protocols based on predicted network conditions, as previously described.

At operation 307, a user's progresses through a setup wizard is guided by recommendations. These recommendations are adapted to network conditions.

At 308, proactive issue resolution may be performed. If potential connectivity issues are detected, a computer assistant provided by architecture 200 proactively suggests solutions in real-time.

At operation 309, user-friendly notifications may be provided. User-friendly notifications may guide a user through a setup process and inform them of any proactive recommendations generated at operation 308. These notifications may be app notifications. Users may receive notifications directly within a dedicated cloud print and scan web-app 210, whether of a computer, pad, phone, or other electronic device. In-app messages can provide real-time information about the predicted connectivity issue, suggest alternative time slots, and offer rescheduling options. Users may receive alert notifications. Architecture 200 may send alert notifications to a user's device, such as on their smartphone or computer. These notifications may appear as pop-ups, banners, or alerts, delivering immediate information about a predicted network change and suggesting alternative time slots. Users may receive email notifications. Email notifications might provide detailed information about a predicted connectivity issue, offer alternative time slots, and include links or instructions for rescheduling a setup. For a cloud-based MFP, such MPF may provide display notifications on a display screen thereof. Such notifications could be presented directly on an MFP interface. This might include on-screen messages or alerts providing information about predicted network conditions and suggesting rescheduling options.

At operation 310, it may be determined whether a current setup process completed successfully. If a then current setup process completed successfully as determined at operation 310, then at operation 311 such a then current setup process may end, including exiting from a setup wizard.

If, however, at operation 310 it is determined that a then current setup process includes one or more unresolved issues, at operation 312 user-friendly instructions or recommendations may be provided to a user to resolve such one or more issues. Unresolved issues encountered during a setup process may include network connectivity problems, preventing a cloud-based device from establishing a reliable connection to one or more cloud services, and so a user may be notified about such connectivity issue with guidance on troubleshooting steps or further actions.

Unresolved issues encountered during a setup process may include configuration errors, namely errors in configuring specific settings used for optimal performance, such as authentication details, server addresses, or protocol configurations. In such instance, a then current setup cannot successfully complete until configuration errors are rectified, and so a user may receive detailed information about each specific configuration issue and instructions for correction.

Unresolved issues encountered during a setup process may include device compatibility issues with a selected cloud service or other connected devices. For such issues, a then current setup process halts, and a user may be informed about such compatibility challenges along with recommendations for resolving compatibility issues or alternative configurations.

Unresolved issues encountered during a setup process may include insufficient user permissions. For example, a user attempting a setup may lack necessary permissions to configure certain settings or access specific cloud services. In such instance, a then current setup attempt remains incomplete, and a user is notified about any and all insufficient permissions. Guidance may be provided on obtaining the required permissions or involving an administrator to complete such setup.

Unresolved issues encountered during a setup process may include a cloud service needed for a setup experiences unexpected downtime or disruptions. In such situation, a then current setup process may be interrupted, and a user may be informed about such service downtime. Recommendations may include waiting for service restoration or selecting an alternative cloud service.

Unresolved issues encountered during a setup process may include an incomplete or interrupted data transfer between a cloud-based device and a cloud service, leading to missing or corrupted information. In which situation, a then current setup process may be deemed unsuccessful, and a user may receive a notification about such incomplete data transfer. Instructions for reinitiating a then current setup or addressing data transfer issues may be provided.

User-centric setup process 300 may end either when a then current setup process is successful, or manual user intervention is needed. However, user-centric setup process 300 illustrates an adaptive and proactive approach of a predictive connectivity optimization architecture 200, ensuring an efficient and user-centric setup experience for cloud-based devices.

Because one or more of the examples described herein may be implemented using an information processing system, a detailed description of examples of each of a network (such as for a Cloud-based SaaS implementation), a computing system, a mobile device, and an MFP is provided. However, it should be understood that other configurations of one or more of these examples may benefit from the technology described herein.

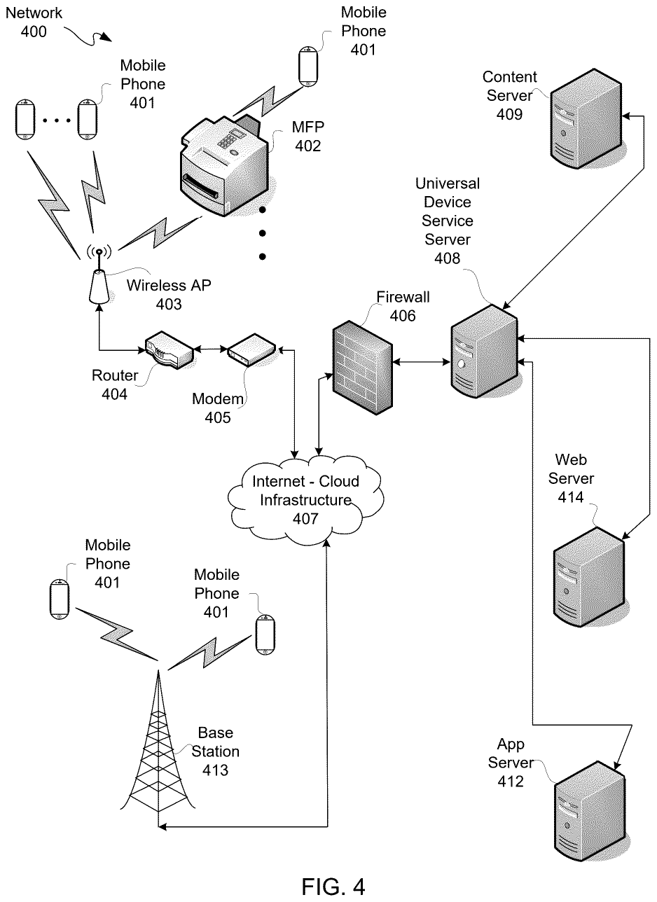

FIG. 4 is a pictorial diagram depicting an example of a network 400, which may be used to provide a SaaS platform of a cloud-based network for hosting a service or micro service for use by a user device, as described herein. Along those lines, network 400 may include one or more mobile phones, pads/tablets, notebooks, and/or other web-usable devices 401 in wired and/or wireless communication with a wired and/or wireless access point (“AP”) 403 connected to or of a wireless router. Furthermore, one or more of such web-usable wireless devices 401 may be in wireless communication with a base station 413.

Additionally, a desktop computer and/or a printing device, such as for example one or more multi-function printer (“MFPs”) 402, each of which may be web-usable devices, may be in wireless and/or wired communication to and from router 404. An MFP 402 may include at least one plasma head as previously described herein.

Wireless AP 403 may be connected for communication with a router 404, which in turn may be connected to a modem 405. Modem 405 and base station 413 may be in communication with an Internet-Cloud infrastructure 407, which may include public and/or private networks.

A firewall 406 may be in communication with such an Internet-Cloud infrastructure 407. Firewall 406 may be in communication with a universal device service server 408. Universal device service server 408 may be in communication with a content server 409, a web server 414, and/or an app server 412. App server 412, as well as a network 400, may be used for downloading an app or one or more components thereof for accessing and using a service or a micro service as described herein.

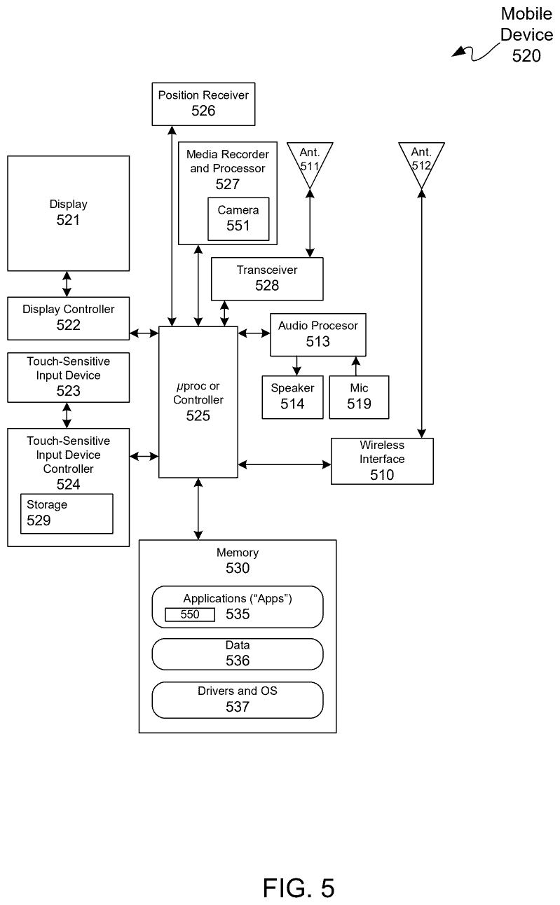

FIG. 5 is a block diagram depicting an example of a portable communication device (“mobile device”) 520. Mobile device 520 may be an example of a mobile device used to instruct a printing device.

Mobile device 520 may include a wireless interface 510, an antenna 511, an antenna 512, an audio processor 513, a speaker 514, and a microphone (“mic”) 519, a display 521, a display controller 522, a touch-sensitive input device 523, a touch-sensitive input device controller 524, a microprocessor or microcontroller 525, a position receiver 526, a media recorder 527, a cell transceiver 528, and a memory or memories (“memory”) 530.

Microprocessor or microcontroller 525 may be programmed to control overall operation of mobile device 520. Microprocessor or microcontroller 525 may include a commercially available or custom microprocessor or microcontroller.

Memory 530 may be interconnected for communication with microprocessor or microcontroller 525 for storing programs and data used by mobile device 520. Memory 530 generally represents an overall hierarchy of memory devices containing software and data used to implement functions of mobile device 520. Data and programs or apps, such as a mobile client application as described hereinabove, may be stored in memory 530.

Memory 530 may include, for example, RAM or other volatile solid-state memory, flash or other non-volatile solid-state memory, a magnetic storage medium such as a hard disk drive, a removable storage media, or other suitable storage means. In addition to handling voice communications, mobile device 520 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 530 stores drivers, such as I/O device drivers, and operating system programs (“OS”) 537. Memory 530 stores application programs (“apps”) 535 and data 536. Data may include application program data. Apps 535 may include an app 550 for an MFP driver. However, in another example, an MFP driver may be included in drivers 537.

I/O device drivers may include software routines accessed through microprocessor or microcontroller 525 or by an OS stored in memory 530. Apps, to communicate with devices such as the touch-sensitive input device 523 and keys and other user interface objects adaptively displayed on a display 521, may use one or more of such drivers.

Mobile device 520, such as a mobile or cell phone, includes a display 521. Display 521 may be operatively coupled to and controlled by a display controller 522, which may be a suitable microcontroller or microprocessor programmed with a driver for operating display 521.

Touch-sensitive input device 523 may be operatively coupled to and controlled by a touch-sensitive input device controller 524, which may be a suitable microcontroller or microprocessor. Along those lines, touching activity input via touch-sensitive input device 523 may be communicated to touch-sensitive input device controller 524. Touch-sensitive input device controller 524 may optionally include local storage 529.

Touch-sensitive input device controller 524 may be programmed with a driver or application program interface (“API”) for apps 535. An app may be associated with a service, as previously described herein, for use of a SaaS. One or more aspects of above-described apps may operate in a foreground or background mode.

Microprocessor or microcontroller 525 may be programmed to interface directly touch-sensitive input device 523 or through touch-sensitive input device controller 524. Microprocessor or microcontroller 525 may be programmed or otherwise configured to interface with one or more other interface device(s) of mobile device 520. Microprocessor or microcontroller 525 may be interconnected for interfacing with a transmitter/receiver (“transceiver”) 528, audio processing circuitry, such as an audio processor 513, and a position receiver 526, such as a global positioning system (“GPS”) receiver. An antenna 511 may be coupled to transceiver 528 for bi-directional communication, such as cellular and/or satellite communication.

Mobile device 520 may include a media recorder and processor 527, such as a still camera 551, a video camera, an audio recorder, or the like, to capture digital pictures, audio and/or video. Microprocessor or microcontroller 525 may be interconnected for interfacing with media recorder and processor 527. Image, audio and/or video files corresponding to the pictures, songs and/or video may be stored in memory 530 as data 536.

Mobile device 520 may include an audio processor 513 for processing audio signals, such as for example audio information transmitted by and received from transceiver 528. Microprocessor or microcontroller 525 may be interconnected for interfacing with audio processor 513. Coupled to audio processor 513 may be one or more speakers 514 and one or more microphones 519, for projecting and receiving sound, including without limitation recording sound, via mobile device 520. Audio data may be passed to audio processor 513 for playback. Audio data may include, for example, audio data from an audio file stored in memory 530 as data 536 and retrieved by microprocessor or microcontroller 525. Audio processor 513 may include buffers, decoders, amplifiers and the like.

Mobile device 520 may include one or more local wireless interfaces 510, such as a WIFI interface, an infrared transceiver, and/or an RF adapter. Wireless interface 510 may provide a Bluetooth adapter, a WLAN adapter, an Ultra-Wideband (“UWB”) adapter, and/or the like. Wireless interface 510 may be interconnected to an antenna 512 for communication. As is known, a wireless interface 510 may be used with an accessory, such as for example a hands-free adapter and/or a headset. For example, audible output sound corresponding to audio data may be transferred from mobile device 520 to an adapter, another mobile radio terminal, a computer, or another electronic device. In another example, wireless interface 510 may be for communication within a cellular network or another Wireless Wide-Area Network (WWAN).

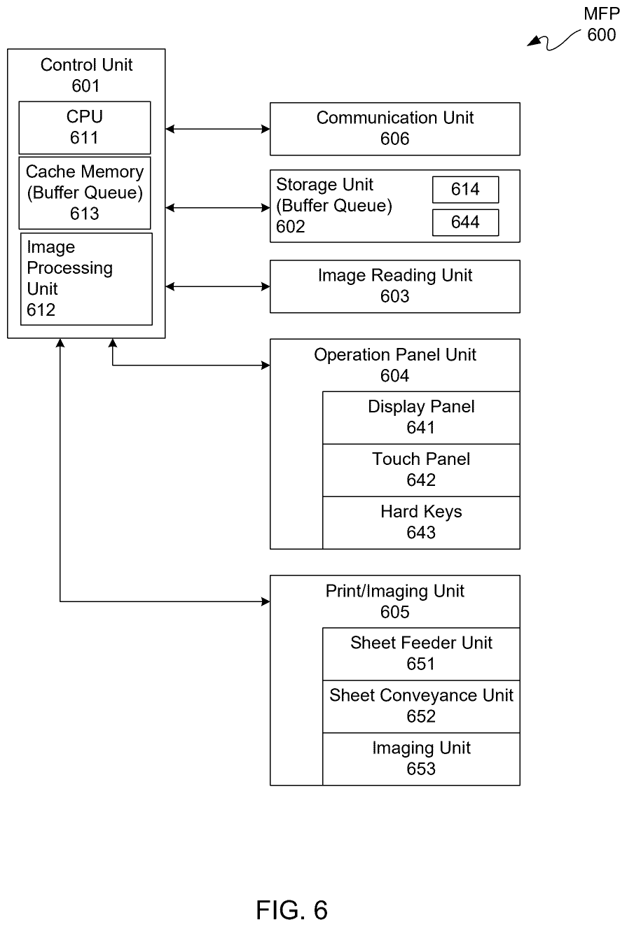

FIG. 6 is a block diagram depicting an example of a multi-function printer MFP 600. MFP 600 is provided for purposes of clarity by way of non-limiting example. MFP 600 is an example of an information processing system such as for handling a printer job.

MFP 600 includes a control unit 601, a storage unit 602, an image reading unit 603, an operation panel unit 604, a print/imaging unit 605, and a communication unit 606. Communication unit 606 may be coupled to a network for communication with other peripherals, mobile devices, computers, servers, and/or other electronic devices.

Control unit 601 may include a CPU 611, an image processing unit 612, and cache memory 613. Image processing unit 612 may be configured with an imposition service 351, as previously described.

Control unit 601 may be included with or separate from other components of MFP 600. Storage unit 602 may include ROM, RAM, and large capacity storage memory, such as for example an HDD or an SSD. Storage unit 602 may store various types of data and control programs, including without limitation a printer imaging pipeline program 614 and a printer job settings app 644. A buffer queue may be located in cache memory 613 or storage unit 602.

Operation panel unit 604 may include a display panel 641, a touch panel 642, and hard keys 643. Print/imaging unit 605 may include a sheet feeder unit 651, a sheet conveyance unit 652, and an imaging unit 653.

Generally, for example, for an MFP a copy image processing unit, a scanner image processing unit, and a printer image processing unit may all be coupled to respective direct memory access controllers for communication with a memory controller for communication with a memory. Many known details regarding MFP 600 are not described for purposes of clarity and not limitation.

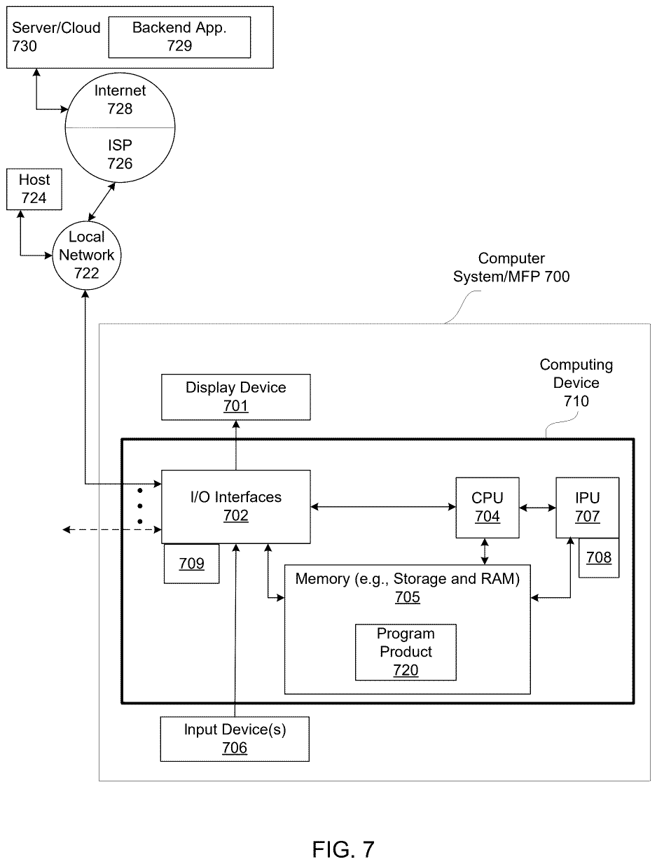

FIG. 7 is a block diagram depicting an example of a computer system or MFP 700 (“computer system”) upon which one or more aspects described herein may be implemented. Computer system 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. Computer system 700 by itself or networked with one or more other computer systems 700 may provide an information handling/processing system.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks. Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include an image processing unit (“IPU”) 707 coupled to CPU 704 and one or more peripheral cards 709 coupled to I/O interface 702. Along those lines, programmed computing device 710 may include graphics memory 708 coupled to optional IPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an NVMe-PCIe bus, SATA bus or other bus. Moreover, one or more SSDs may be used, such as for NVMe, RAID or other multiple drive storage for example.

I/O interface 702 may include chip set chips, graphics processors, and/or daughter cards, among other known circuits. In this example, I/O interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and I/O interface 702. Along those lines, IPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide a program product 720. Program product 720 may be for implementing portions of process flows, as described herein. For example, program product 720 may include an information and document handling manager for a programmed document server for feeding documents for processing with flow 200 of FIG. 2. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise.

One or more program(s) of program product 720, as well as documents thereof, may define functions of examples hereof and can be contained on a variety of non-transitory tangible signal-bearing media, such as computer-or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using computer system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to computer system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

Computer system 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or another Internet service provider. ISP 726 may in turn provide data communication services through a world-wide packet data communication network, the “Internet” 728. Local network 722 and the Internet 728 may both use electrical, electromagnetic or optical signals that carry analog and/or digital data streams. Data carrying signals through various networks, which carry data to and from computer system 700, are exemplary forms of carrier waves for transporting information.

Wireless circuitry of I/O interface 702 may be used to send and receive information over a wireless link or network to one or more other devices' conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WIFI (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WIFI), and/or a long range wireless transceiver (e.g., GSM/GPRS, UMTS, CDMA2000, EV-DO, and LTE/LTE-Advanced) can be used depending on the type of communication or the range of the communication.

Computer system 700 can send messages and receive data, including program code, through network(s) via a network link and communication interface of I/O interface 702. In the Internet example, a server 730 might transmit a requested code for an application program through Internet 728, ISP 726, local network 722 and I/O interface 702. A server/Cloud-based system 730 may include a backend application for providing one or more applications or services as described herein. Received code may be executed by processor 704 as it is received, and/or stored in a storage device, or other non-volatile storage, of memory 705 for later execution. In this manner, computer system 700 may obtain application code in the form of a carrier wave.

While the foregoing describes exemplary apparatus(es) and/or method(s), other and further examples in accordance with the one or more aspects described herein may be devised without departing from the scope hereof, which is determined by the claims that follow and equivalents thereof. Claims listing steps do not imply any order of the steps. Trademarks are the property of their respective owners.

What is claimed is:

1. A system for cloud-based equipment of a cloud network, comprising:
a network prediction module configured to use first machine learning to predict network conditions using first historical data to provide predicted network conditions for the cloud network;
a dynamic scheduling module in communication with the network prediction module and configured to determine optimal times for operations by the cloud-based equipment based on the predicted network conditions; and
a predictive load balancing module in communication with the network prediction module and configured to use second machine learning to forecast server loads using second historical data to provide forecasted server loads and to distribute tasks in response to the forecasted server loads to reduce high-load conditions on any single server of servers of the cloud-based equipment.

2. The system according to claim 1, wherein the predicted network conditions include one or more of predicted bandwidth, predicted latency, or predicted stability of the cloud network.

3. The system according to claim 2, wherein the network prediction module utilizes historical network metrics of the first historical data to train a predictive model associated with the first machine learning and to train the predictive model with the predicted network conditions as predictions made at specified intervals to account for fluctuating network conditions.

4. The system according to claim 1, wherein the dynamic scheduling module uses a Random Forest model to generate latency and stability estimates for each device setup based on specified bandwidth thresholds.

5. The system according to claim 1, wherein the predictive load balancing module includes a predictive model class that forecasts future server load distribution based on historical load data of the second historical data and schedules tasks to prevent processor high-load conditions.

6. The system according to claim 5, wherein the cloud-based equipment includes cloud-based printing devices.

7. The system according to claim 6, wherein one or more of the cloud-based printing devices are not co-located with one or more of the servers of the cloud-based equipment.

8. The system according to claim 1, wherein the network prediction module is configured to predict one or more of bandwidth fluctuations, latency variations, or stability issues of the cloud-based network.

9. The system according to claim 1, further comprising a control interface coupled to the network prediction module, the dynamic scheduling module, and predictive load balancing module to allow a user to interact with each thereof.

10. The system according to claim 9, wherein the control interface includes a web application and a computer assistant.

11. The system according to claim 10, further comprising a real-time notifications module coupled to the network prediction module and configured to provide alerts to changes in conditions of the cloud network.

12. The system according to claim 10, further comprising a real-time notifications module coupled to the network prediction module and configured to provide alerts to configuration errors during the device setup.

13. The system according to claim 12, wherein the dynamic scheduling module is configured to determine the optimal times for operations by document processing devices of the cloud-based equipment based on the predicted network conditions.

14. The system according to claim 13, further comprising an adaptive configuration recommendations module in communication with the network prediction module and configured to provide adaptive configuration recommendations based on the predicted network conditions and user preferences.

15. The system according to claim 14, wherein the predictive load balancing module includes a predictive model class configured for load balancing responsive to decisions made based on predicted future loads.

16. The system according to claim 15, wherein the predictive load balancing model is configured to select the servers based on the predicted future loads.

17. The system according to claim 12, wherein the device setup is for a cloud-based print device.

18. The system according to claim 17, wherein the device setup is for a cloud-based scan device.

19. The system according to claim 18, wherein the computer assistant is configured to initiate analysis to predict the network conditions.

20. The system according to claim 19, further comprising real-time monitoring tools configured to monitor the network conditions during the device setup.
